(19) United States
(12) Patent Application Publication
(10) Pub. No.: US 2006/0016315 A1
(43) Pub. Date: Jan. 26, 2006

(54) Saw cutting blade

(76) Inventors: Timothy A. Zorich, Agoura, CA (US); Chad J. King, Moorpark, CA (US)

Correspondence Address: JAMES F KIRK, 16365 MARUFFA CIRCLE, HUNTINGTON BEACH, CA, 92649-2134, US

(21) Appl. No.: 11/183,110

(22) Filed: Jul. 15, 2005

Related U.S. Application Data
(60) Provisional application No. 60/590,795, filed on Jul. 23, 2004.

(51) Int. Cl. B23D 47/00

(52) U.S. Cl. 83/835; 83/663

(57) ABSTRACT

A saw blade having blade body supporting a leading cutting edge for cutting through a workpiece. A force and motion are applied to drive the cutting edge against the work piece as the body of the saw blade is driven with a reciprocating, rotational or linear motion transverse to the applied direction of the force. The solid rectangular cross section of a saw blade is modified to improve its ability to cut through a workpiece. The body of the blade is characerized as having cut out areas distributed throughout the blade body to capture and remove the debris from the kerf. This improved cutting performance can be further enhanced by reducing the cross section of the body. Secondary cutting edges may also be incorporated around the perimeter of the cutouts and as part of the reduced geometry portion of the blade body.

This non-provisional patent applicaton claims priority from provisional patent application 60/590,795 filed on Jul. 23, 2004 for An Improved Saw Cutting Blade, and having common inventors.

### BACKGROUND

This invention relates to the field of tools and more particularly to the field of cutting tools and blades for saws.

The cross-sectional side walls of the aft blade body (also referred to as “Aft Body”) which structurally supports the cutting edge of the typical saw blades used with all types of hand saws, reciprocating saws, rotary saws or band saws with motorized drives, exclusive of the cutting edge, generally is solid and has a uniform rectangular cross section. There may also be a few nominal cut out regions, notched regions or indented regions within the walls of the body to act as cooling vents, for stress relief, or to facilitate blade bending when cutting non linear shapes. The cutting edge is typically formed in various type of tooth like geometries with sharpened or angled teeth at the leading edge of the blade and grooves between the teeth cut to the root of the cutting edge as shown in FIGS. 1b and 1c, or as a continuous sharpened leading edge as shown in FIGS. 29a and 29b. The cutting edge makes a cut in a workpiece that forms a gap or kerf having a width equal to or slightly greater than the width of the rectangular body of the blade. An increased gap space in the kerf permits debris material generated by the cutting action to either exit the kerf or, if it remains in the kerf, reduces the degree of contact between the trapped debris and the walls of the kerf and the blade, as the blade advances.

The debris is irregular in form. If the width of the cutting edge of the blade has the dimension “T”, the particles of debris being formed will vary in size, some being slightly larger and some being slightly smaller than the dimension T. For the particles to move between the wall of the body of the blade and the cut-wall of the kerf being formed in the workpiece, the particles must be realigned or further reduced in size. This task is accommodated by the cutting edge and the action of the saw; however, some of the debris particles can be expected to be simply realigned and passed into the gap between the blade body and the wall of the kerf with little reduction in size. Those particles having a larger size, and those smaller particles that cluster together, rapidly fill the space between the wall of the body of the blade and the cut-wall as the velocity of the blade is increased to its steady state cutting speed, forming a frictional mass of material that generates heat, stress and drag on both the blade and workpiece, contributes to the work and time required to drive the blade through the workpiece and can result in poor quality to the surface of the material being cut. Other saw blades, such as Circular saw blades, may have a small step reduction in the dimension of the blade body at the Aft Root line with a constant Aft Body cross section from that point to the back edge of the blade. This can help somewhat to reduce friction but still leaves the debris, as cut, in the gap between the kerf wall and the blade body to randomly cluster and does not facilitate movement and removal of the debris.

### SUMMARY OF THE INVENTION

An improved saw or cutting blade is taught herein by designing new features and benefits into the Aft Body of the blade or Aft Blade Region, which is the portion integral to and behind the Primary Cutting Edge Region of the blade. This invention relates to improvement in the design of the aft blade region and side walls of a saw or cutting blade which is not the portion of the blade body that is best characterized as the Primary Cutting Edge Region. The improvements are designed to capture debris formed by the cutting operation, reduce its size, transport it and remove it from the gap or kerf formed in the material being cut.

Examples of blades encompassed would include motorized blades, such as those used with a motorized reciprocating saw sometimes referred to as a “sawzall” or “jig” saw and non-motorized blades used with all types of handsaws. The invention also applies to band saw blades with a continuous linear motion and circular saw blades. It can be used for cutting wood, ceramics, crystals, glass, steel, stone and concrete. Non-motorized examples include one and two person band saws, all hand saws and any saw or blade with a Primary Cutting Edge that is supported by an Aft Body.

The Aft Body is improved by forming (cutting, perforating, etching or stamping) cutout patterns into the Aft Body either part way or completely through the body which are designed specifically to capture the cut debris, transport it away from the wall of the Kerf, further reduce the size of the debris particles and enhance it's removal from the Kerf. The cutout patterns in the Aft Body are formed as close as practical to the Aft Root Line of the Primary Primary Cutting Edge of the blade while sufficient Aft Body material for maintaining sufficient structural strength and integrity to support the stress and strain encountered by the blade during the cutting operation. The distance is based upon the material of the blade body (steel, aluminum, alloy, ceramic, cermet, etc.) its structural characteristics, the material being cut, the properties of the debris and the characteristics of the motion and force driving the blade. This distance to the leading edge of the cutout pattern will generally range between 1 mm and 25 mm distance from the Aft Root Line of the Primary Cutting Edge, depending on the size of the blade, the body material and the type of material to be cut. A variety of shapes for such cutout patterns will be characterized as examples along with data taken for several different samples demonstrating the improved blade performance characterized by reduced cutting time. Such shapes include well known geometric patterns, random patterns, tire tread-like patterns, circular and elongated elliptical holes, or combinations thereof. These patterns are designed and positioned to maximize the capture the debris as close to the Primary Cutting Edge Region as practical removing it from contact with the wall of the Kerf, then based on the type of motion of the blade (recipricating, rotary or linear), transport the debris away from the Primary Cutting Surface, then carry the debris as quickly as possible out of the Kerf region. The patterns therefore consist of an open area in the Aft Body behind and close to the Primary Cutting Edge Region followed by a region to carry and transport the debris away from that region and finally a region to either act as a reservoir for the debris or to transport it out of the Kerf. The cutout pattern can be single large open geometric patterns (such as parallelograms, rectangles, diamonds or triangles ) or many patterns distributed over the body of the blade as in FIGS. 3 thru 7, 14, and 15, or a combination of patterns in the body of the blade connected together by cutout regions between them thus forming a single complex cutout pattern such as FIGS. 16, 23, 24 and 25, or combinations of these.

Further improvements to the Aft Body of the blade which can be used solely or in addition to the cutout patterns described above, include reducing or modifying the cross sectional dimensions of the the Aft Body. A traditional cross section of an unmodified blade would be a solid rectangular or a single small step at the Aft Root Line of the blade. The improved cross section is reduced to have a shape including the following list such as: tapered, more than one step reduction(s), curved or hourglass as in FIGS. 8-13 or any modification of the Aft Body reducing its cross sectional dimension from the Aft Root Line of the Primary Cutting Edge Region to the back edge of the blade.

The Aft Body is further improved by adding secondary cutting or grinding surfaces to the perimeter of the cutout regions or within the reduced cross sections of the Aft Body to further enhance the cutting action or to grind the debris into smaller size particles than that formed by the primary cutting action of the blade. These secondary surfaces can be saw blade-like surfaces having sharp edges around the cutout regions, cheese grater like, small spiked areas or other types of geometric or random protrusions to provide the enhanced cutting or grinding action. FIGS. 10 through 13 represent blade like surfaces formed within the body from among those described above. FIGS. 4, 5 and 14 show sharpened and serrated edges added around the perimeter of the cutout patterns as several examples of adding secondary cutting surfaces within the perimeter region of the cutouts.

### BRIEF DESCRIPTION OF THE DRAWINGS

FIG. 1a is a side view of a standard recipricating saw blade of various cross-sections taken on line 8-8;

FIG. 1b is an enlarged side view of the circled Region A of the saw blade in FIG. 1a;

FIG. 1c is a view of the blade teeth with FIG. 1b rotated 90 degrees;

FIG. 2a is a side view, tilted at a slight angle, showing the cutting blade and block being cut as arranged to test cutting speed;

FIG. 2b is a side view, tilted at a slight angle, showing the Kerf or cut out region of the material being cut, with the blade removed;

FIG. 3 is a side view of circular or elliptical cutout patterns;

FIG. 4 is a side view of a second embodiment of the cutout patterns;

FIG. 5 is a side view of a third embodiment of the cutout patterns;

FIG. 6 is a side view of a fourth embodiment of the cutout patterns;

FIG. 7 is a side view of a fifth embodiment of the cutout patterns;

FIG. 8 is a first sectional view of a cross section of the blade of FIG. 1a showing a first cross section;

FIG. 9 is a second sectional view of a cross section of the blade of FIG. 1a showing a first cross section;

FIG. 10 is a third sectional view of a cross section of the blade of FIG. 1a showing a first cross section;

FIG. 11 is a fourth sectional view of a cross section of the blade of FIG. 6 showing a first cross section;

FIG. 12 is a fifth sectional view of a cross section of the blade of FIG. 6 showing a first cross section showing a secondary saw blade surface;

FIG. 13 is a sixth sectional view of a cross section of the blade of FIG. 6 showing a first cross section showing a grating like surface;

FIG. 14 is a side view of a one handed saw with embodiment of the cutout patterns and a secondary cutting edge along the bottom perimeter wall of the cutouts;

FIG. 15 is a side view of a two handled saw with embodiment of the cutout patterns;

FIG. 16 is a side view of a band saw blade with cutouts consisting of several connected regions to capture, transport, store and remove the debris

FIG. 17 is a first sectional view of a cross section of the blade of FIG. 16 showing a first cross section A-A showing partially penetrating cutouts;

FIG. 18 is a second sectional view of a cross section of the blade of FIG. 16 showing a second cross section B-B;

FIG. 19 is a third sectional view of a cross section of the blade of FIG. 16 showing a third cross section C-C;

FIG. 20a. is a fourth sectional view of a cross section of the blade of FIG. 16 showing a fourth cross section D-D with fully penetrating cutouts;

FIG. 20b. is an option to the fourth sectional view of a cross section of the blade of FIG. 16 showing a variation of the fourth cross section D-D;

FIG. 20c. is an option to the forth sectional view of a cross section of the blade of FIG. 16 showing yet another variation of the fourth cross section D-D;

FIG. 21 is a fifth sectional view of a cross section of the blade of FIG. 16 showing a fifth cross section E-E with fully penetrating cutouts;

FIG. 22 is a sixth sectional view of a cross section of the blade of FIG. 16 showing a sixth cross section F-F;

FIG. 23 is a side view of a rotary saw blade with several connected cutout regions to capture, transport, store and remove the debris

FIG. 24 is the side view of a rotary saw blade with a cutout Corkscrew-Like Pattern to capture, transport, store and remove the debris

FIG. 25 is side view of a saw blade with embodiment of cutouts in the form of a tread pattern

FIG. 26 is a sectional view of a cross section of the blade of FIG. 25 showing a first cross section taken on section line A-A;

FIG. 27 is a sectional view of a cross section of the blade of FIG. 25 showing a second cross section taken on section line B-B;

FIG. 28 is a sectional view of a cross section of the blade of FIG. 25 showing a third cross section taken on section line C-C;

FIG. 29a is side view of a cutting blade having oval cutouts;

FIG. 29b is sectional view of the cutting blade of FIG. 29 taken on section line A-A;

FIGS. 30-33 are side views of cutting blades depicting four different cutout patterns.

### THE PREFERRED EMBODIMENT

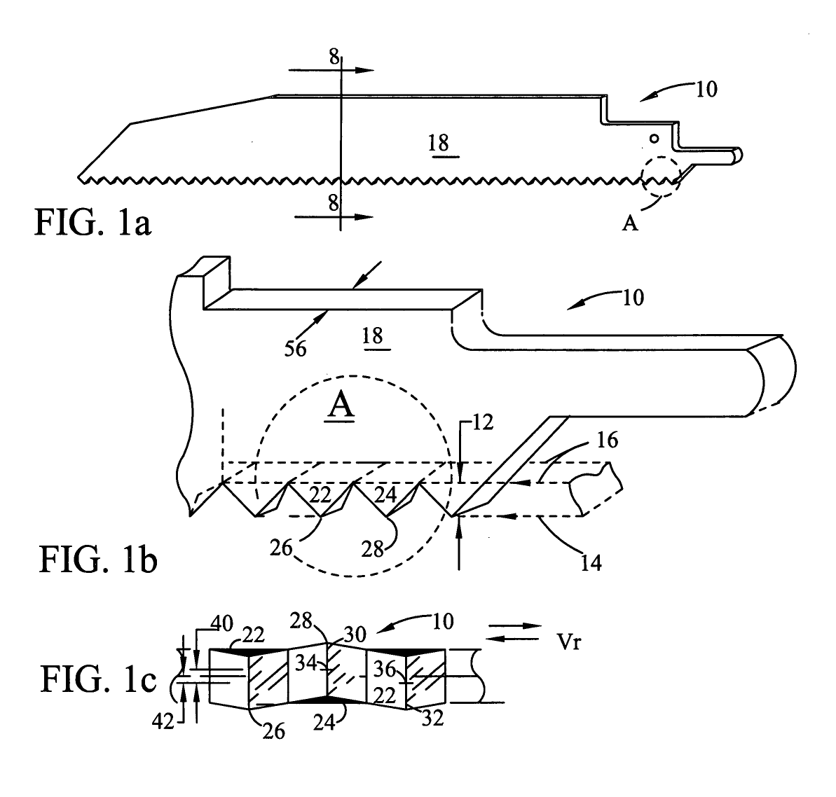

FIG. 1a. shows a typical reciprocating Saw Blade 10. FIG. 1b shows an expanded region “A” of FIG. 1a that is identified by phantom circle and the letter “A” in each of the views. FIG. 1b is expanded to schematically show several of the saw teeth on the sawblade of FIG. 1a for the purpose of identifying and naming parts of the SawBlade 10 and the saw teeth that are shown with particularity. Saw Blade 10 has a Primary Cutting Edge Region 12 between phantom lines that extend from the Cutting Edge of phantom line 14 to the Aft Root Line or plane identified by phantom line 16. The Primary Cutting Edge Region 12 is at the leading edge of the blade. In addition to the Primary Cutting Edge Region 12, each saw blade has an Aft Body 18 that is integral to and behind the Primary Cutting Edge Region 12, the regions being contiguous along the Aft Root Line 16.

Early Comments on the Circular Blade

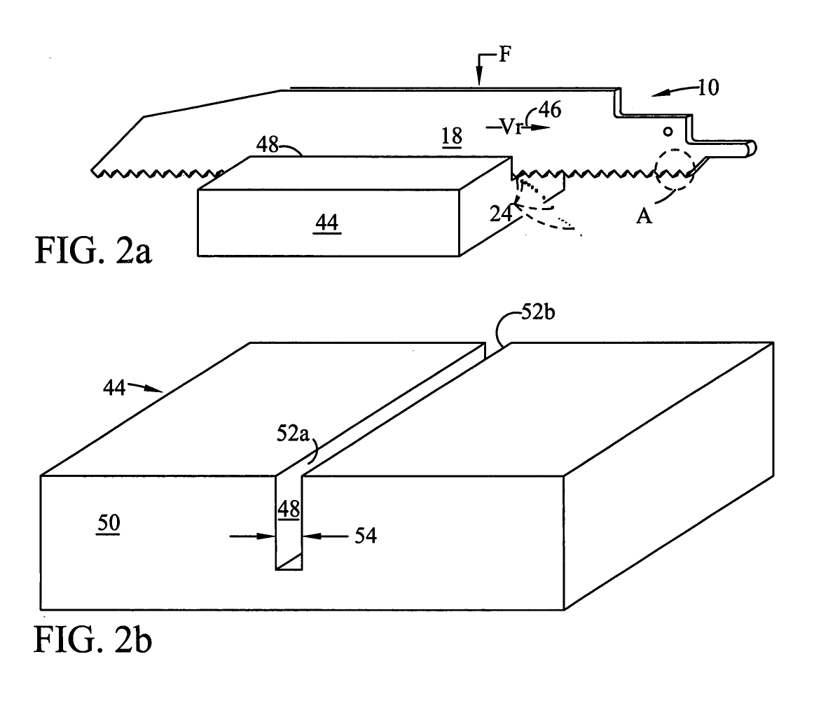

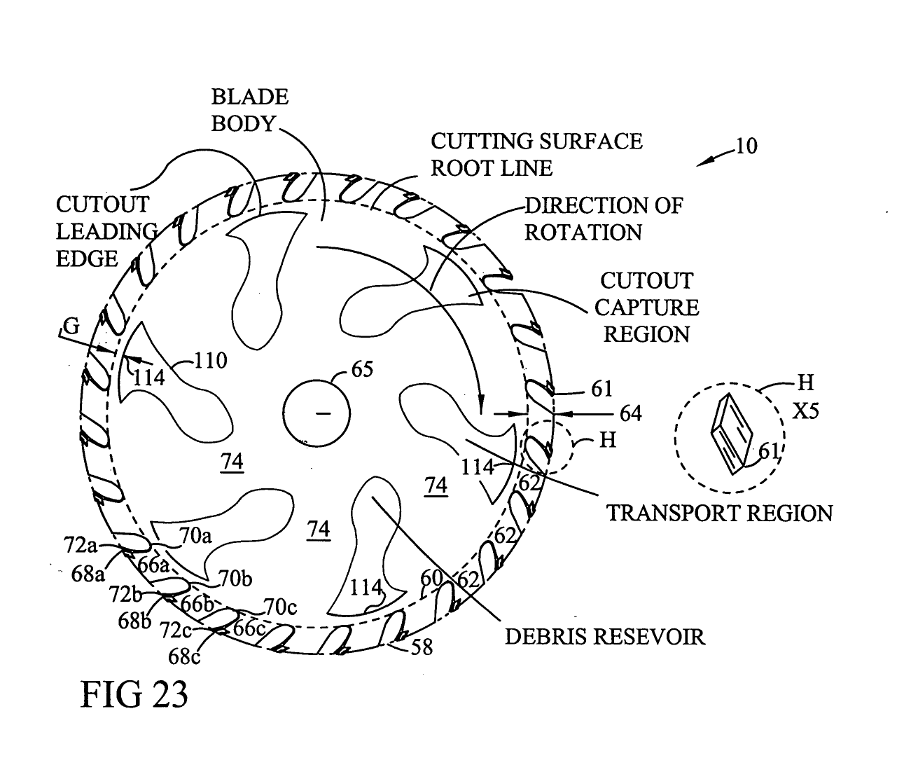

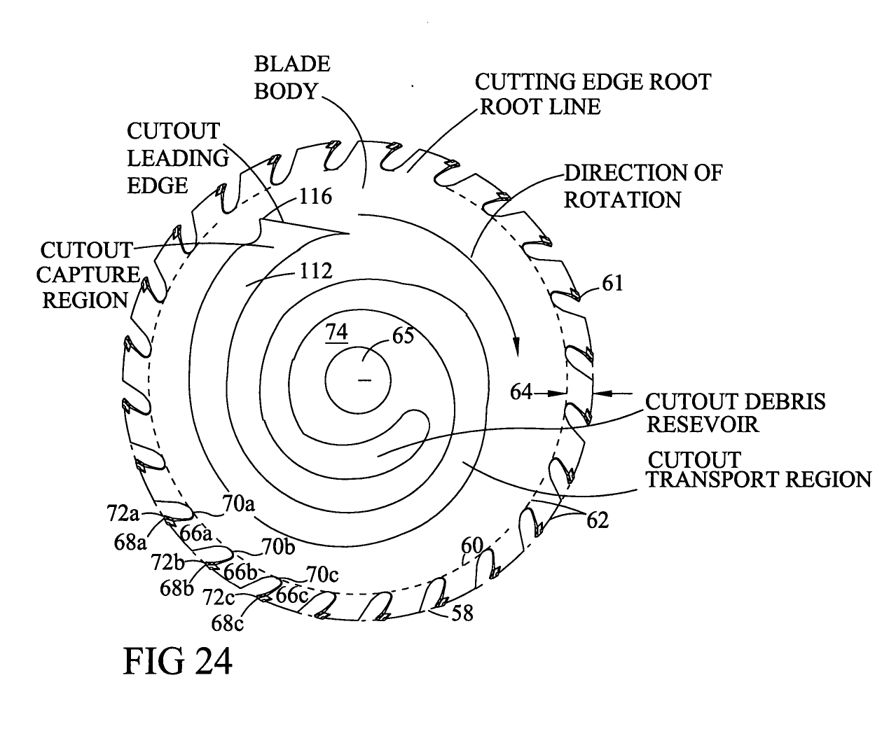

FIGS. 23 and 24 each show a phantom line 60 that identifies the location of the Aft Root Line 60 as it passes the root of the teeth formed in the Primary Cutting Edge Region 62 between the Circular Saw Cutting Edge 58 and the Aft Root Line 60. The Primary Cutting Edge Region 62 is functionally equivalent to the Primary Cutting Edge Region 12 depicted in FIG. 1b. FIGS. 23 and 24 also show that each tooth on the blade has a hardened tip element 61 made of hardened material that is attached to each tooth. For many circular blades each of tip elements 61 or the pattern of tips elements is slightly wider than the material of the aft blade body region 74 to which the tip element is attached. Insert drawing H on FIG. 23 shows a tip element magnified with a power of five. The functional equivalent of the Primary Cutting Edge Region 12 in the straight blades of FIGS. 1b, 16 and 25 exists in the circular blades of FIGS. 23 and 24 in the Circular Saw Primary Cutting Edge Region 62 positioned between the Circular Saw Cutting Edge 58 and the Circular Saw Aft Route Line 60. The hardened tip elements 61 are typically slightly wider than the thickness of the material of the blade body. If the Kerf 48 in FIG. 2b is cut with the Circular Saw Blades of FIGS. 23 and 24, the Kerf 48 will have a Workpiece Channel Gap 54 that is slightly larger than the thickness of the material from which the circular blade is produced because of the use of the hardened tip elements 61. In other circular saw blades the Circular Saw Cutting Edge 58 is a single row of cutting teeth equal to or narrower in width than the Aft Body. Yet in other Circular Saw Blades, the Circular Saw Cutting Edge 58 is a continuous region with no teeth, sharpened at the Circular Saw Cutting Edge 58. Some such blades have a Primary Cutting Edge Region 62 tapered to the increased dimension of the Aft Body Region 74 at the Aft Root Line 60.

Straight Blade Aft Root Line

FIG. 1b shows that the Primary Cutting Edge Region 12 extends from the outermost periphery of the blade at Cutting Edge 14 inward to the Aft Root Line 16 shown as a phantom line passing along the root of the teeth in FIG. 1b. FIG. 1c shows several teeth in the edge of a straight blade. The cutting edge of successive teeth in FIG. 1c are rotated four degrees in alternating direction to show a slight twist in the Sawtooth Set. In practice, the angle of rotation can be greater than the angle used in the drawing. The twist in the Sawtooth Set is intended to make alternating teeth more effective in cutting as the Saw Blade 10 of a recipricating saw or hand saw travels in alternate directions with half the tips providing an enhanced cut in a forward direction and the remaining tips providing an enhanced cut as the direction of the blade is reversed.

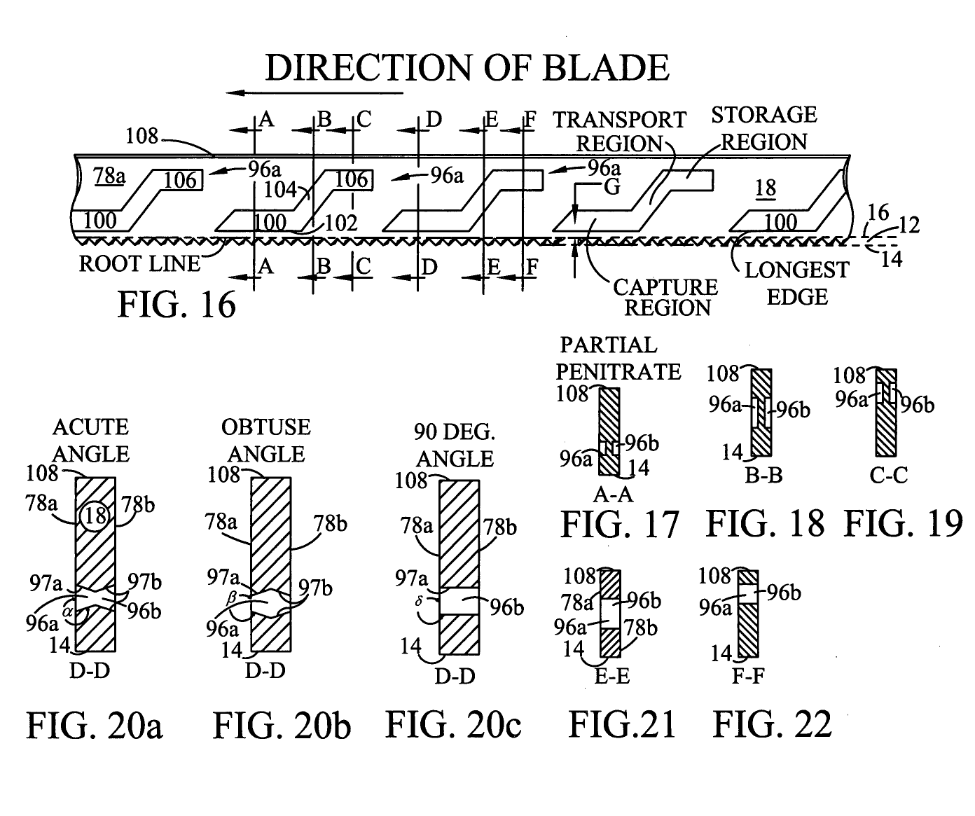

Widening the blade in the Cutting Edge Region 12 has the objective of achieving a widened Kerf 48, in which Workpiece Channel Gap 54, shown in FIG. 2b, exceeds that of the blade width 56 shown in FIG. 1b. A widening of the Cutting Edge Region 12 can assist the blade in moving through the Kerf 48 and in carrying and moving cooling and cleaning fluid to and from the Kerf 48. Saw Blades, such as the Band Saw Blade in FIG. 16, that operate in one direction can have a Blade Set but may omit the alternating twist because the blade is not expected to reverse its direction.

FIG. 2a shows the reciprocating saw blade 10 cutting into a Workpiece 44, such as a piece of 2×4 inch wood. Arrow 46 indicates that the blade is in motion and is moving to the right with velocity Vr in the present cycle. Debris particles 24 are schematically represented by small objects trailing and falling out of a Kerf 48 as the Saw Blade moves to the right. Many of the debris particles 24 remain in the Kerf Region 48 due to the limited tranverse motion of the blade. A normal force F is applied vertically at the rear edge of the blade to drive the blade continuously downward into the Kerf 48. FIG. 2b shows the Workpiece 44 rotated in a clockwise direction to expose the Kerf 48 as the reciprocating motion continues. FIG. 2b shows the workpiece 44 with Saw Blade 10 removed from the Kerf 48. An end view of the Kerf 48 appears on Workpiece Face 50. The material that the workpiece is made from will depend on the application, but common materials include materials such as wood, metal, stone, concrete or plastic. As shown in FIG. 2b, the Kerf 48 has opposing walls 52a, 52b separated by the Workpiece Channel Gap 54 which is equal to or slightly larger that the thickest portion of the Saw, the Aft Body 18, of Cutting Blade 10 that produced the Kerf 48. Referring again to FIG. 1c, if the Saw Blade 10 has a Saw Blade Set 40, the Saw Blade Set 40 will enable the Saw Blade 10 to cut a Kerf 48 that has a Workpiece Channel Gap 54 that is slightly wider than the thickness 56 of the Aft Body 18, shown in FIG. 1b.

FIG. 16 shows an improved saw blade specifically designed for operation in a single direction with a velocity Vr, as indicated by the direction arrow pointing from right to the left shown on the drawing. Phantom line 14 locates the Cutting Edge 14 and phantom line 16 locates the Aft Root Line or plane 16. As in the discussion above relating to FIG. 1b, the Primary Cutting Edge Region 12 lays between the Cutting Edge 14 and the Aft Root Line 16.

Circular Saw Blades

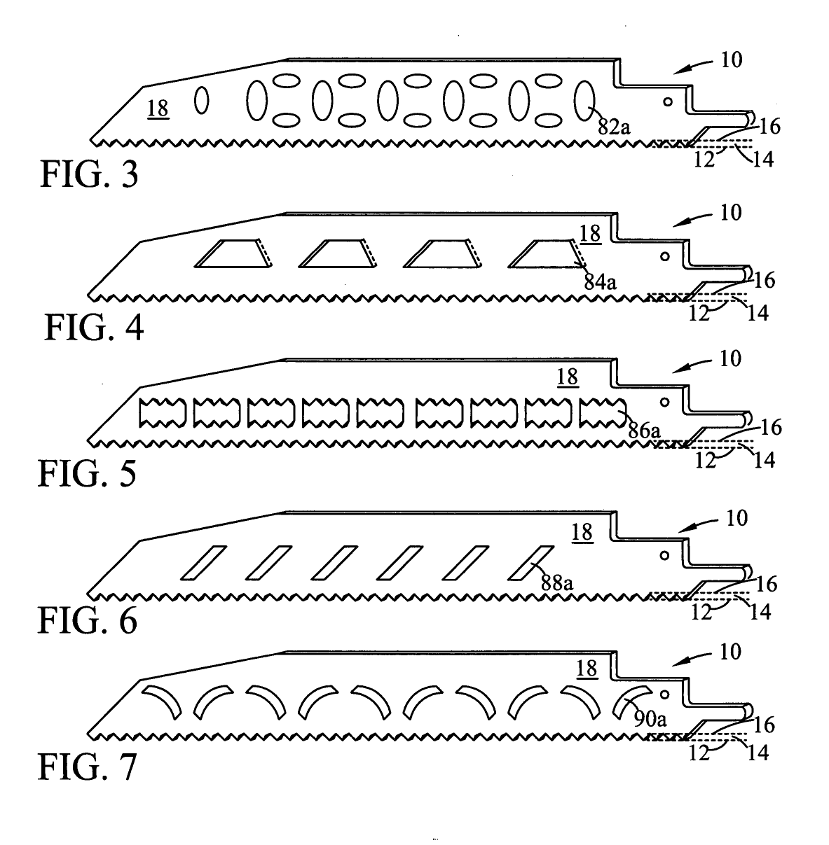

The Circular Saw Blades of FIGS. 23 and 24 also have the features of the Improved Saw Blade of FIG. 16, and FIGS. 3, 4, 5, 6 and 7. As shown in FIG. 23, the region between the Circular Saw Cutting Edge 58 and the Circular Saw Aft Root Line 60 is the Circular Saw Primary Cutting Edge Region 62. Dimension 64 shows the depth of the Primary Cutting Edge Region 62 as it extends inward. In FIGS. 23 and 24, the Circular Saw Aft Root Line 60 encompasses a series of Peripheral Saw Teeth 66a, 66b . . . 66n. Each saw tooth 66a, 66b, 66c has a tip 68a, 68b, 68c and an aft root 70a, 70b, 70c. Each saw tooth shown an edge 72a, 72b, 72c, the edges being aligned in a circle 58 to form the Circular Saw Cutting Edge 58. In FIG. 23, the aft roots 70a, 70b, 70c are in a circle with a center at the center of Hub 65. The circle forms the Circular Saw Aft Root Line 60. The Circular Saw Aft body 74 includes the material and void space between the Hub 65 and the Circular Saw Aft Root Line 60.

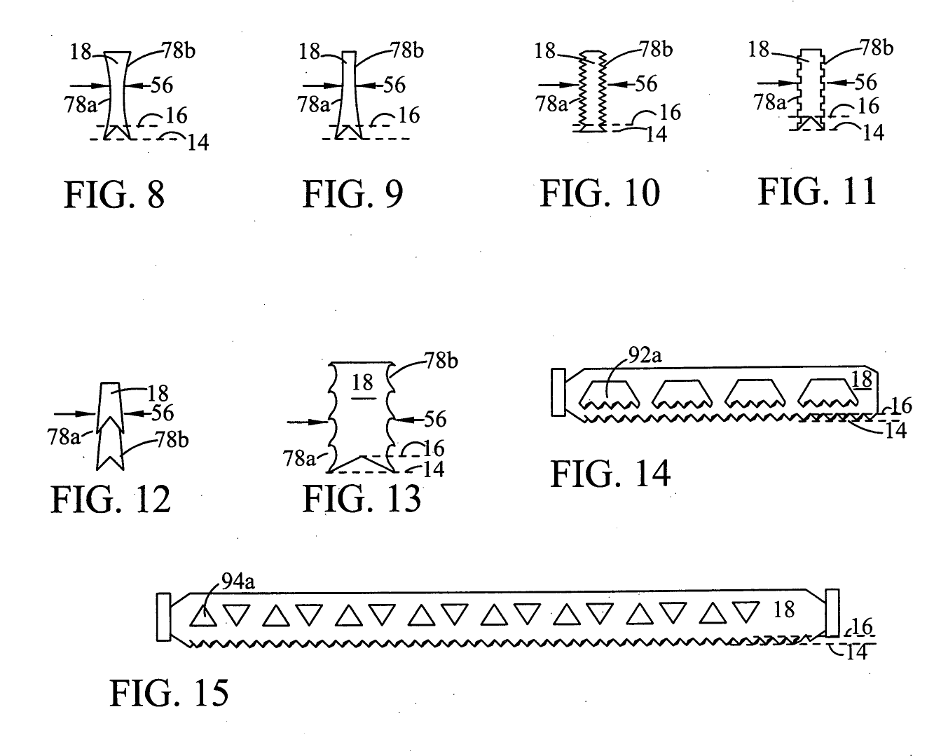

FIGS. 3-7, 14, 15 and 16 each show a primary cutting edge 14, an aft root line 16, and a Primary Cutting Edge Region region 12 as well as an Aft Body 18 that extends behind the Primary Cutting Edge Region 12. The Aft Body 18 has opposing faces 78a, and 78b on opposing sides of the Saw Blade 10. The opposing face 78b is not shown in the FIGS. 3-7, 14, 15 and 16. However, the opposing faces 78a and 78b are indicated in the sectional drawings of FIGS. 8-13. FIGS. 8-13 are sectional drawings of FIG. 1a taken on section line 8-8 that show alternative cross sectional designs of the saw blade Aft Body 18 that are tailored to reduce the friction between the blade faces 78a and 78b and the walls 52a and 52b of the Kerf 48, further reduce the particle size of the debris in the Kerf 48, and enhance the extraction rate of debris 24. FIGS. 3-7, 14, 15, 16 and 25 each show at least one cutout pattern such as cutout patterns 82a, 84a, 86a, 88a, 90a, 92a, 94a, 96a and 98a reduce the particle size, and the extraction rate of debris 24. The cutout pattern(s) 82a, 84a, 86a, 88a, 90a, 92a, 94a, 96a and 98a are also formed on the opposing faces 78b (not shown) of the Aft Body.

FIGS. 17-22 are sectional drawings of cutout pattern 96a of FIG. 16, taken on section lines A, B, C, D, E and F. FIGS. 20a-20c are three sectional drawings, magnified by a power of two taken on section line D-D to show cutout pattern walls 97a, 97b at three angles α, β, δ with respect to the opposing faces 78a, 78b. Each cutout pattern has perimeter walls, such as those shown in connection with the sectional drawings of FIGS. 20a-20c cut into the opposing faces 78a, 78b of the Aft Body 18.

FIGS. 17-19 are sectional drawings taken on section lines A-A through C-C of FIG. 16. Each of these sectional drawings shows a different portion of the cutout pattern 96a, 96b that only partially penetrates the Aft Body 18. FIGS. 20a-22 on the other hand, show portions of the pattern 96a, 96b that totally penetrate the Aft Body 18. The election to partially penetrate or totally penetrate the Aft Body 18 and the election to use a particular cutout pattern is made with consideration given the blade's size and thickness 56, the material that the blade 10 is to cut, and on empirical test data that relate to the size and design of the blade 10.

The cutout pattern(s) 82a, 84a, 86a, 88a, 90a, 92a, 94a, 96a and 98a capture the debris formed as the saw teeth cut through the material of the workpiece. The cutout patterns are also designed and arranged in their location to enhance the removal of the debris from the Kerf 48 as the saw teeth lead the blade through the workpiece 44. Cutting debris and removal of debris in the process of sawing through a workpiece 44 reduces friction between the walls of the Kerf 52a, 52b and the opposing sides of the blade 78a, 78b, as the Kerf 48 is formed. Reduced friction and enhanced removal of debris also increase the speed at which a given blade cuts through a workpiece 44 and reduces the amount of energy required of the cutting tool to cut through the material.

The blade 10 configurations shown in FIGS. 3-7, 14, 15, 16 and 25 provide designs adaptable, with minor changes, to be saw blades for use in tools such as a hand saw, a band saw, a reciprocating saw such as a saws-all or jig saw, a circular or rotating saw, or even a hollow cylindrical hole saw in which the blade is rolled into the form of a tube.

The cutout pattern 96a has the shape of the mirror image of flattened letter “Z”. The blade 10 of FIG. 16 is suitable for cutting in one direction. As debris enters the cutout pattern 96a on the opposing face 78a, the material is collected in a first horizontal cutout region 100 having a lower horizontal edge 102 nearest the primary cutting edge region 12, or more particularly nearest the aft root line 16. After entering the horizontal cutout region 100, the debris is moved by the motion of angled cutout region 104 into the second horizontal cutout region 106 near the top edge 108 of the Aft Body 18. As the debris is moved toward and collected in the second horizontal cutout region 106 in the cutout pattern 96a, it is further reduced in size while in transit after which the debris passes out of the Kerf as the capture region 106 exits the material, or the debris proceeds to the top edge of the Aft Body 108, enters the Kerf behind the Aft Body and no longer interferes with the walls of the blade and kerf as the blade continues it's motion to the left exiting the Kerf. The capture and removal of the debris from the Kerf 48 during the movement of the blade through the body reduces the friction between the walls of the Kerf being formed and the blade body surfaces, 78a and 78b, and removes the captured debris from the Kerf as the blade exits the body thus reducing the friction and reducing the energy required to perform the cut.

FIGS. 20a-20c are alternative sectional drawings of FIG. 16 taken on line D-D that show that the cross section of the cutout pattern formed in the opposing faces 78a, 78b of the Aft Body 18. FIG. 20a shows the cutout pattern walls 97a, 97b formed at an acute angle α of less than 90 degrees measured with respect to the face 78a of the aft body 18. FIG. 20b shows the cutout pattern walls 97a, 97b formed in the opposing faces 78a, 78b of the Aft Body 18 at an obtuse angle β of more than 90 degrees measured with respect to the face 78a of the Aft Body 18. FIGS. 17, 18, 19, 20c, 21, and 22 each show the cutout patterns walls 97a, 97b forming a right angle δ of substantially 90 degrees measured with respect to the face 78a or 78b of the Aft Body 18 with respect to the wall used as a reference. The significance of cutout walls angled at less than 90 degrees (acute angles) to the blade body is to permit easier entry of the debris into the cutout pattern to facilitate debris capture, while 90 degree or greater angled walls will enhance the retention of the debris in the cutout region by creating a debris dam preventing the debris from leaving the cutout and returning to the Kerf, and can act to further cut and reduce the size of the debris as the blade motion moves these surfaces against the captured debris. Thus by angling or tapering, at an acute angle, the leading edge of the capture region, and retaining a steep angle of 90 degrees or more for the remainder of the cutout, the performance of the blade can be even further enhanced. FIGS. 10 through 13 and 16 through 28 show a variety of cutout patterns and corresponding cross-sectional drawings taken on the cutout patterns in which the perimeter wall of one or more cutout pattern(s) is formed into one or more secondary cutting edges. As a reciprocating blade, or a hand saw moves in alternate directions, the perimeter edges of a cutout regions will produce shear.

FIGS. 8-13, are sectional drawings taken on section line 8-8 of FIG. 1a that show the Aft Body 18 can have a reduced cross sectional thickness 56 starting at the aft root line 16. The Aft Body thickness is reduced as a wedge shape in a linear fashion sloping inward from the cutting edge 14. The cross sectional drawing of FIGS. 8 and 9 show examples of the aft body thickness 56 being reduced as a gradual curved shape sloping from the cutting edge 14 or from the aft root line 16. FIGS. 12 and 13 are secondary cutting body configurations. FIGS. 10 and 11 show the Aft Body 18 being reduced in cross sectional thickness from that of the cutting edge thickness or at aft root line 16 in one or more step reduction(s) in dimension. Sectional drawings 8-13 have localized regions above the aft root line 16 that are reduced in cross sectional thickness. A reduction in cross sectional thickness 56 provides greater clearance between the opposing walls of the Aft Body 18 and the walls of the Kerf 48, thereby reducing friction between the walls of the Kerf and the opposing walls of the Aft Body 18.

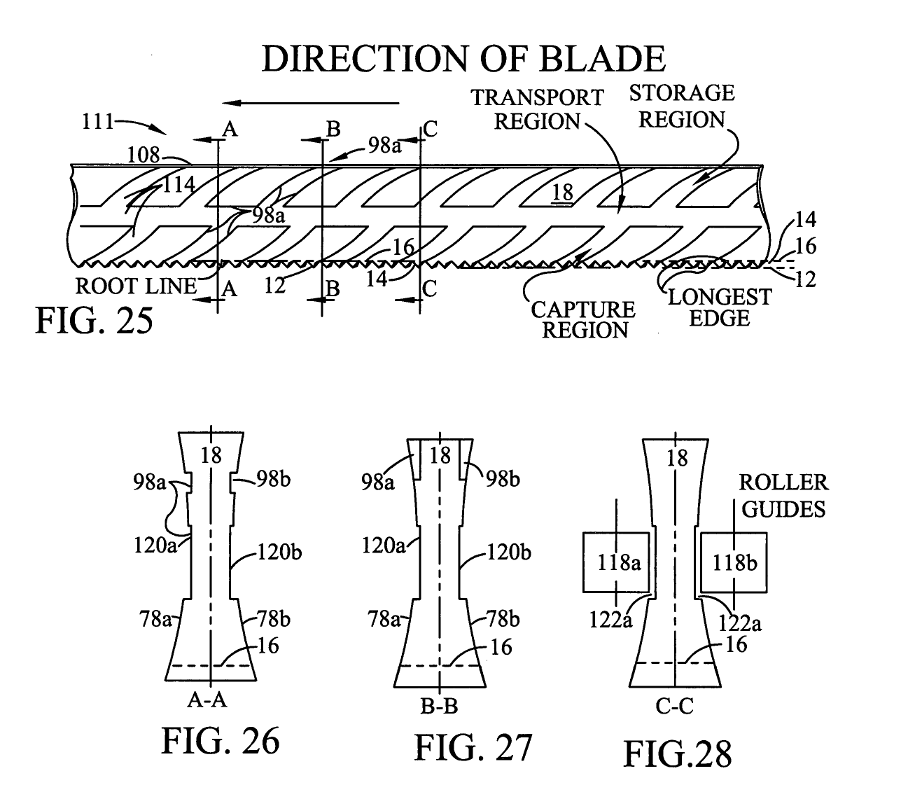

FIG. 25 shows a one directional continuous blade 111 that has a cutout pattern 114 in the Aft Body 18 which is a tire tread-like cutout pattern 98a. The sectional drawing of FIGS. 26-28 show the cutout pattern 114 in section lines taken at stations A-A through C-C. Each sectional view shows a reduction in cross sectional thickness extending from a point at or above the aft root line 16 with the expectation of reduced friction due to an increased gap between the wall of the Kerf and the opposing walls of the Aft Body 18.

The sectional drawing of FIGS. 26-28 show that the cutout pattern 98a does not penetrate the entire thickness of the Aft Body. FIG. 28 shows rollers 11 8a, 11 8b on the left and right side of the aft blade body 18. The one directional continuous blade 111 FIG. 25 is particularly adapted for use in a band saw application in which the one directional continuous blade 111 is driven by drive rollers (not shown). Guide Rollers 118a, 118b grip, stabilize and guide the continuous blade 111 on the left and right side of the aft blade body 18. The rollers ride in central grooves or central channels 120a, 120b characterized to provide smooth passage of the saw blade as it is restrained by rollers 118a, 118b. The guidance of the rollers 118a, 118b on the left and right side of the aft blade body 18 provide the greatest reduction in vibration if positioned at points immediately above and below a workpiece being passed through the blade 111. For blades with a uniform body thickness (no reduction in body thickness) having cutout patterns in the body, the blade can a be driven by rollers that have a width equal to or wider than the entire width of the body of the blade.

Returning again to the circular blade of FIGS. 23 and 24, cutout pattern 110 and cutout pattern 112 each have a lower horizontal edge or longest edge 114 and 116 respectively, similar to the lower horizontal edge or longest edge 102 that appears in the straight blade of FIG. 16. FIGS. 23 and FIG. 24 each have a circular saw aft root line 60 similar to the aft root line 16 shown on FIG. 1b, FIGS. 3-7, and FIG. 16. The distance between the circular blade longest edge 102 and the aft root line 60 is also shown as dimension G on FIGS. 23 and 24. A separation distance G in the range of from 1 to 25 mm is expected to be useable; however, the dimension used on a particular blade will depend on the size and material of the blade, the material of the workpiece, cutting speed as well as other variables along with the results of empirical tests of the blade and on blades of related designs.

The range of designs are possible for aft body cutout patterns include the pattern designs of FIGS. 3-7, 14, 15, 16, 23, 24, and 25 as well as designs, not shown, that include dimples, indentations, depressions and designs using grooves. FIG. 25, discussed above, provides an example of a cutout pattern of a design selected from the class of cutout patterns that include the tire tread-like cutout pattern 114. The circular blade of FIG. 23 has a cutout pattern 110 on circular saw blades that includes a scoop format cutout channel. The scoop format pattern could have been made to include randomly distributed channels. The circular blade of FIG. 24 has a cutout pattern 112 that has a spiral or corkscrew like pattern in appearance.

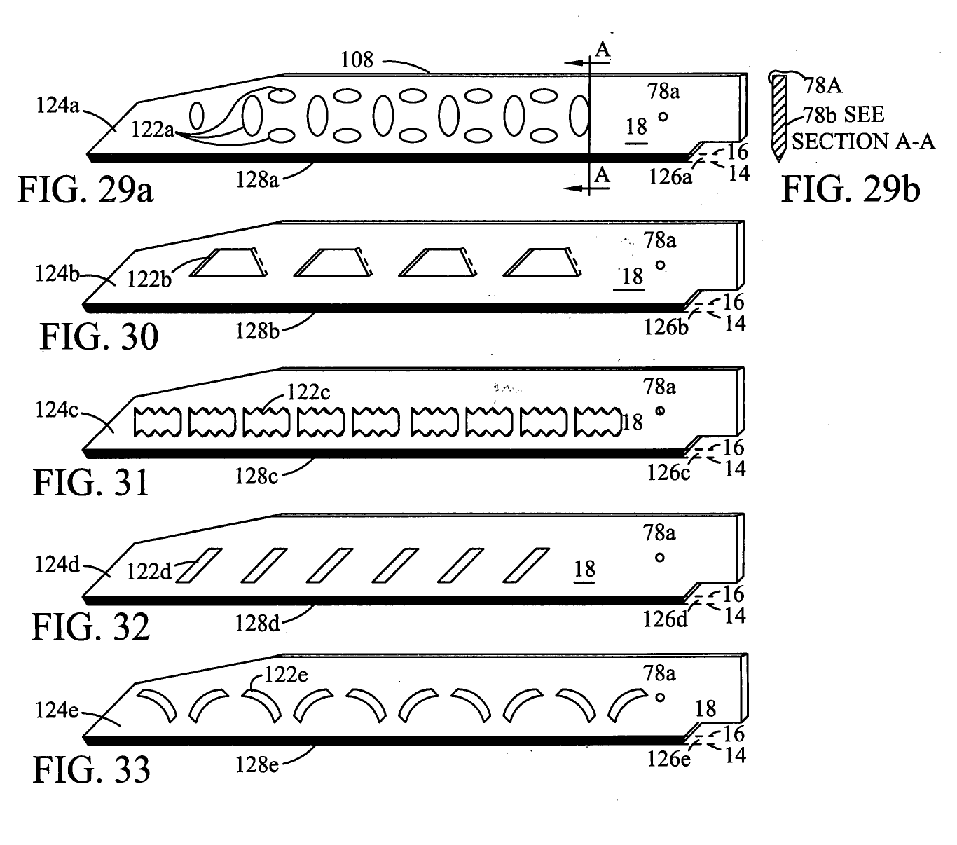

FIGS. 29a through 33 show cutout patterns 122a-122e on cutting blades 124a-124e, each having an Aft Body 18 with a cutout pattern matching the cutout patterns in FIGS. 3-7. Each cutting blade has Primary Cutting Edge Regions 126a-126e at the leading edge of the Aft Body 18. Each of the Aft Body 18 is integral to and behind the corresponding wedge shaped region or Primary Cutting Edge Region 128a-126e which includes sharpened leading edges 128a-128e at the leading edge of corresponding Primary Cutting Edge Region or wedge shaped regions 126a-126e. The wedge shaped regions 126a-126e are formed by the removal of blade material to form the sharpened leading edges 128a-128e at the apex of the left and right side of each blade as shown in FIG. 29b.

The back edge of the wedge shaped region 126a-126e is the equivalent in function to the aft root line 16 discussed above in connection with straight and round saw blades. The aft root line is located at, and contiguous, homogenous and integral with, the leading edge of the Aft Body 18. The line identified as plane 16, formed by the back edge of the wedged region, is functionally identical to the aft root line 16 referred to in FIG. 1b and other earlier Figures. The Aft Body 18 starts at the aft root line 16. Friction develops between the wall of the Kerf in the material being cut, and the walls of the aft blade body 18. The Aft Body 18 has at least one cutout pattern formed in the opposite faces 78a (shown) and 78b (not shown) of the Aft Body. The cutout pattern(s) reduce friction between the opposite faces of the blade body and opposing walls of the Kerf in the material being cut. The cutout patterns also capture any debris that is formed as the blade reciprocates or is imparted with the cutting motion, which enhances removal of the debris from the Kerf and removes the debris from contact with the walls of the Kerf and the blade.

In the rotary blades of FIGS. 23 and 24, as in the band saw blade of FIG. 16, the cutout regions are designed with a tilt away from the direction of rotation or linear motion, the tilt starting at the leading edge of the cutout pattern closest to the blade primary cutting edge region. This allows the blade motion, and centrifugal force produced by blade movement on the loose debris, to enhance the movement of the debris from the initial capture region toward the debris reservoir or storeage regions away from the walls of the Kerf and then out of the Kerf as quickly as possible. FIG. 24 shows a corkscrew pattern design to further enhance capture and transport of debris.

FIG. 25 shows one of many possible tread like pattern cutouts in the body of saw blade, in this case a band saw blade. The tread patterns in the blade are designed to collect the debris in the Kerf and channel it out of the region being cut as the cut is being made using the motion of the blade to enhance the movement of the debris. This is much like conventional automobile tire tread patterns which capture water on the road surface and channel it out of the interface between the rolling tire and the road surface. In the case of this invention, the tread pattern in the blade is designed to optimize the capture, transport and removal of the type and physical characteristics of the debris formed in the specific type of materials being cut by a blade. Different patterns will be required for different materials with different debris characteristics. FIGS. 26, 27 and 28 show 3 cross sectional views of the tread like cutout patterns extending part way into the body of the blade. The slant of the treads from the cutting edge to the central tread and from the center tread to the back side of the blade are designed to use the linear motion of the bandsaw to aid in the transport of the debris away from the cutting edge to the center tread area and then toward the back side of the blade. The captured debris will be expelled when the section of the blade transits out of the material. Similarly for a rotary or circular saw, a corkscrew like pattern of FIG. 24 would collect and transfer debris away from the cutting edge toward the center of the blade where there would be a central debris reservoir. For each type of blade and cutting motion, the capture, transfer and reservoir patterns are designed, based upon the blade motion, material being cut and debris characteristics, to optimize the capture, transfer and removal of the cut debris from the Kerf.

TABLE 1 below provides actual measured “time to cut” data taken with blades modified per the invention per the figures above. The test data was obtained using standard, as purchased, wood 2″×4″'s , cut by new, unmodified, as purchased, off the shelf commercial saw blades in a motorized reciprocationg saw. Pairs of comparative values were obtained using wood from the same piece of wood. The second cut time was measured in each case using the same reciprocating motor and identical off the shelf blades modified with the cutout patterns per this invention indicated in the Table 1. The modifications are generally as depicted and described in FIGS. 3 through 7, 14 and 15. Every effort was made to reproduce the down force and angle of all cuts by allowing the weight of the saw to apply the cutting pressure and holding the saw blade across the 2″ dimension of the wood at a right angle. The time for each of the cuts are in seconds unless otherwise noted. The final 6^{th} cut was made to a larger 6″×10″ dry wooden beam, such as those used in heavy construction as large structural members. The time was measured in minutes and seconds.

### Performance Data

Three (3) cuts were made with each blade. Data represents “time to cut” data taken with blades modified with cutout patterns per the invention, identified in Table 1. Test data obtained using standard, as purchased, wood 2″×4″'s , cut by new, unmodified, as purchased, off the shelf commercial saw blades in a motorized reciprocationg saw, and then wood from the same pieces, cut again with the same reciprocating motor and identical off the shelf blades improved with cutout patterns per this invention. Every effort was made to duplicate the downward force and the angle of all cuts by allowing the weight of the saw to apply the cutting pressure and by holding the saw blade across the 2″ dimension of the wood at an estimated right angle. Times for the cuts are in seconds unless otherwise noted. FIG. 2b shows the arrangement of the cutting blade and the piece of wood being cut in the five tests of Table 1. The 6^{th} cut was made to a larger 6″×10″ dry wooden beam (1 cut only) comparable to those used in heavy construction as large structural members. The time required appears in minutes and seconds.

TABLE 1
Cutting Time with Unmodified and Modified Blades

| Blade Design | Time Unmodified | Time Modified |
|---|---|---|
| Figure #; Type of Cutout | (seconds) | (seconds) |
| Cut 2″ × 4″ Wood | | |
| FIG. 3; Round Holes | 11.41 | 11.42 |
| a. 9.50 | | |
| b. 12.66 | | |
| FIG. 15; Triangular Holes | 18.11 | 10.17 |
| a. 10.16 | | |
| b. 11.23 | | |
| FIG. 4; Partial Triangular Holes | 16.85 | 14.43 |
| (Blade had 10 cuts before test) | 15.92 | 14.42 |
| a. 13.60 | | |
| FIG. 5; Slots Parallel to Body Length | 12.78 | 12.73 |
| a. 11.29 | | |
| b. 12.55 | | |
| FIG. 6; Slots At 45 Degrees to Body | 20.67 | 17.62 |
| (Blade had 10 cuts prior to test) | 21.10 | 15.48 |
| a. 13.67 | | |
| Cut 6″ × 10″ Wood (1 cut only) | | |
| FIG. 15; With Triangular Holes | 2 min 41 sec | 2 min 5 sec |

In this application, FIGS. 1 thru 33 illustrate a few of the many different shapes or patterns that are envisioned for the invention modification of the Aft Body which can produce the aforementioned improvements and which represent a small number of the possible embodiments of this invention. Performance benefits that result from the improvement to the body of the blade are believed to include the following:

Decreased cutting time.

Accelerated removal of cut debris from the kerf.

Reduced friction between the blade body and the cut-wall of the kerf.

Reduced heating of the blade.

Reduced stress on the blade.

Reduced expenditure of energy by the machine or the person using the saw.

Increased battery life in portable power cutting tools.

Less wear on the motor and hardware.
Longer blade life.
Little increase to the manufacturing cost of the improved blade.
Compatibility with existing motorized machine cutting tools.

Those skilled in the art will appreciate that various adaptations and modifications of the preferred embodiments can be configured without departing from the scope and spirit of the invention. It is to be understood that the invention may be practiced other than as specifically described herein, within the scope of the appended claims.

What is claimed is:

1. A saw blade comprising:
a blade body, having a primary cutting edge at the leading edge of the blade for cutting a kerf in a workpiece, debris being formed from workpiece material produced in forming the kerf,
the primary cutting edge of the saw blade comprising a series of saw teeth, each saw tooth having a tip and an aft root, each saw tooth being in a row and having edges aligned in a plane to form a cutting surface and the aft roots being in line to form an aft root line,
an Aft Body behind the primary cutting edge, the Aft Body having opposing faces with at least one cutout pattern, each cutout pattern having perimeter walls cut into the opposing faces of the Aft Body, the cutout pattern(s) being formed on opposite sides of the Aft Body, such cutout pattern(s) being designed to capture the debris, enhance removal of the debris from the kerf, and reduce friction between the blade body and the kerf as the kerf is formed.

2. The saw blade of claim 1 wherein the saw blade is further characterized to be a saw blade from a hand saw.

3. The saw blade of claim 1 wherein the saw blade is further characterized to be a saw blade from a band saw.

4. The saw blade of claim 1 wherein the saw blade is further characterized to be a saw blade from a reciprocating saw.

5. The saw blade of claim 1 wherein the saw blade is further characterized to be a saw blade from a rotating saw.

6. The saw blade of claim 1 wherein the saw blade is further characterized to be a saw blade from a hollow cylindrical hole saw.

7. The saw blade of claim 1 wherein:
the cutout pattern is formed in the opposing faces of the Aft Body, the cutout pattern being further characterized as comprising cutout regions having cutout walls at an angle of 90 degrees or less measured with respect to the corresponding opposing face of the Aft Body.

8. The saw blade of claim 1 wherein:
the cutout pattern is formed in the opposing faces of the Aft Body, the cutout pattern being further characterized as comprising cutout regions having cutout walls at an angle of more than 90 degrees with respect to the corresponding opposing face of the Aft Body.

9. The saw blade of claim 1 wherein:
the cutout pattern(s) formed in the face of the Aft Body having an edge closest to the aft root line, the distance between the edge closest to the aft root line and the aft root line being in the range of 1 mm to 25 mm.

10. The saw blade of claim 1 wherein:
the cutout pattern(s) formed in the Aft Body are of different shapes and geometries distributed over the Aft Body of the saw blade.

11. The saw blade of claim 1 wherein:
the cutout pattern(s) formed in the Aft Body are identical patterns distributed over the Aft Body of the saw blade.

12. The saw blade of claim 1 wherein:
the perimeter wall of one or more cutout region(s) is formed into one or more secondary cutting edges.

13. The saw blade of claim 1 wherein:
the Aft Body has a reduced cross sectional thickness starting at the aft root line.

14. The saw blade of claim 13. wherein:
the Aft Body reduced cross sectional thickness is reduced from that of the cutting edge in one or more step reduction(s) in dimension.

15. The saw blade of claim 13. wherein:
the Aft Body thickness is reduced as a wedge shape in a linear fashion sloping inward from the cutting edge.

16. The saw blade of claim 13. wherein:
the aft body thickness is reduced as a gradual curved shape sloping from the cutting edge.

17. The saw blade of claim 13. wherein:
the cutout patterns in the aft body are tire tread-like patterns.

18. The saw blade of claim 1 wherein:
the aft body has cutout patterns of a design selected from the class of cutout patterns that include dimples, indentations, depressions and grooves.

19. The saw blade of claim 1 wherein:
the Aft Body has cutout patterns of a design selected from the class of cutout patterns that include tire tread-like patterns, randomly distributed channels, and corkscrew patterns.

20. A saw blade comprising a blade body, the blade body having:
a primary cutting edge at the leading edge of the blade for cutting a kerf in a workpiece, debris being formed from workpiece material produced in forming the kerf, and
an Aft Body behind and integral with the cutting edge, the Aft Body having opposing faces with at least one cutout pattern formed in the opposite faces of the Aft Body, such cutout pattern(s) being designed to penetrate partially through the Aft Body, to capture the debris, enhance removal of the debris from the kerf, and reduce friction between the Aft Body and the kerf as the kerf is formed.

21. A saw blade comprising:
a blade body, the blade body having a primary cutting edge at the leading edge of the blade for cutting a kerf in a workpiece, debris being formed from workpiece material produced in forming the kerf,
an Aft Body behind and integral with the cutting edge, the Aft Body having opposing faces with at least one cutout pattern formed in the Aft Body, such cutout pattern(s) being designed to penetrate completely through the Aft Body, to capture the debris, enhance removal of the debris from the kerf, and reduce friction between the Aft Body and the kerf as the kerf is formed.

22. A cutting blade having a blade body comprising:
a primary cutting edge at the leading edge of the body, and an Aft Body integral to and behind the primary cutting edge consisting of opposite body faces,
the primary cutting edge comprising a sharpened leading edge and a wedge shaped region formed by the removal of blade material to form the sharpened leading edge ending in a back edge, the back edge of the wedge shaped region ending at the aft blade body, and the line formed by the back edge of the wedged region being referred to as the primary cutting edge aft root line,
the Aft Body starting at the primary cutting edge aft root line behind and integral with the primary cutting edge having friction between the wall of the material being cut and the Aft Body, the Aft Body having at least one cutout pattern formed in the corresponding opposing faces of the Aft Body, such cutout pattern(s) being designed to reduce friction between the blade body and walls of the material being cut and to capture any debris that is formed to enhance removal of the debris from the cut region.

23. The cutting blade of claim 22 wherein:
the cutout pattern is formed in the opposing faces of the Aft Body, the cutout pattern being further characterized as comprising cutout regions having cutout walls at an angle of 90 degrees or less measured with respect to the corresponding opposing face of the Aft Body.

24. The cutting blade of claim 22 wherein:
the cutout pattern is formed in the opposing faces of the Aft Body, the cutout pattern being further characterized as comprising cutout regions having cutout walls at an angle of more than 90 degrees with respect to the corresponding opposing face of the Aft Body.

25. The cutting blade of claim 22 wherein:
the cutout pattern(s) formed in the face of the Aft Body having an edge closest to the aft root line, the distance between the edge closest to the aft root line and the aft root line being in the range of 1 mm to 25 mm.

26. The cutting blade of claim 22 wherein:
the cutout pattern(s) formed in the Aft Body are of different shapes and geometries distributed over the Aft Body of the cutting blade.

27. The cutting blade of claim 22 wherein:
the cutout pattern(s) formed in the Aft Body are of identical shapes and geometries distributed over the Aft Body of the cutting blade.

28. The cutting blade of claim 22 wherein:
the Aft Body having cutout patterns of a design selected from the class of cutout patterns that include dimples, indentations, depressions and grooves.

29. The cutting blade of claim 22 wherein:
the Aft Body having cutout patterns of a design selected from the class of cutout patterns that include tire tread-like patterns, randomly distributed channels, and corkscrew patterns.

30. The cutting blade of claim 22 wherein:
the perimeter wall of one or more cutout region(s) is formed into one or more secondary cutting edges.

31. The cutting blade of claim 22 wherein:
the Aft Body has a reduced cross sectional thickness starting at the aft root line.

32. The cutting blade of claim 22 wherein:
the Aft Body reduced cross sectional thickness is reduced from that of the cutting edge in one or more step reduction(s) in dimension.

33. The cutting blade of claim 22 wherein:
the Aft Body thickness is reduced as a wedge shape in a linear fashion sloping inward from the cutting edge.

34. The cutting blade of claim 22 wherein:
the Aft Body thickness is reduced as a gradual curved shape sloping from the cutting edge.

35. The cutting blade of claim 22 wherein:
the cutout patterns in the Aft Body are tire tread-like patterns.

36. The cutting blade of claim 22 wherein:
the Aft Body having opposing faces with at least one cutout pattern formed in the opposite faces of the Aft Body, such cutout pattern(s) being designed to penetrate partially through the Aft Body.

37. The cutting blade of claim 22 wherein:
the Aft Body having opposing faces with at least one cutout pattern formed in the Aft Body, such cutout pattern(s) being designed to penetrate completely through the Aft Body.
